(19) United States
(12) Patent Application Publication
(10) Pub. No.: US 2017/0351932 A1
(43) Pub. Date: Dec. 7, 2017

(54) METHOD, APPARATUS AND COMPUTER PROGRAM PRODUCT FOR BLUR ESTIMATION

(71) Applicant: Nokia Technologies Oy, Espoo (FI)

(72) Inventors: Mithun Uliyar, Bangalore (IN); Gururaj Putraya, Bangalore (IN); Basavaraja S V, Bangalore (IN)

(21) Appl. No.: 15/536,083

(22) PCT Filed: Nov. 23, 2015
(86) PCT No.: PCT/FI2015/050812

§ 371 Date: Jun. 14, 2017

(30) Foreign Application Priority Data
Dec. 19, 2014 (IN) 6418/CHE/2014

(51) Int. Cl. G06K 9/62; G06T 7/174; G06K 9/00; G06T 5/00

(52) U.S. Cl. CPC G06K 9/6202; G06T 5/003; G06T 7/174; G06K 9/00281; G06T 2207/20201

(57) ABSTRACT

In an example embodiment a method, apparatus and computer program product are provided. The method includes facilitating simultaneous capture of a first image by a first camera and a second image by a second camera associated with a device. One or more distortion parameters associated with a distortion in the second image may be determined based on a comparison of the second image with at least one template image associated with the second image. A distortion-free first image is generated based on the one or more distortion parameters associated with the second image by performing one of applying the one or more distortion parameters to the first image, and estimating one or more distortion parameters associated with the first image based on the one or more distortion parameters associated with the second image, and applying, the one or more distortion parameters associated with the first image to the first image.

### TECHNICAL FIELD

Various embodiments, relate generally to method, apparatus, and computer program product for blur estimation in media content.

### BACKGROUND

Various electronic devices such as cameras, mobile phones, and other devices are widely used for capturing media content, such as images and/or videos of a scene. During acquisition of the media content by the electronic devices, the media content may get deteriorated, primarily due to random noise and blurring. For example, the images of scene objects, primarily mobile objects that are captured by the electronic devices may appear blurred. In some other scenarios, in case the electronic device being utilized for capturing the media content is in motion, the captured media content may appear blurred. For example, in case a user's hand with which the user may be holding the electronic device is shaking, the media content captured by the electronic device may appear blurred. In some scenarios, techniques may be applied for handling the blurring in the media content, however such techniques are time-consuming and computationally intensive.

### SUMMARY OF SOME EMBODIMENTS

Various example embodiments are set out in the claims.

In a first embodiment, there is provided a method comprising: facilitating capture of a first image by a first camera and a second image by a second camera associated with a device, the first image and the second image being captured simultaneously; determining one or more distortion parameters associated with a distortion in the second image based on a comparison of the second image with at least one template image associated with the second image; and generating a distortion-free first image based on the determination of the one or more distortion parameters associated with the second image, wherein generating the distortion-free first image comprises performing one of: applying the one or more distortion parameters associated with the second image to the first image, and estimating one or more distortion parameters associated with the first image based on the one or more distortion parameters associated with the second image, and applying, the one or more distortion parameters associated with the first image to the first image.

In a second embodiment, there is provided a method comprising: facilitating capture of an image comprising at least one first image portion and at least one second image portion, the at least one second image portion comprising a face portion; determining one or more distortion parameters associated with a distortion in the at least one second image portion based on a comparison of the at least one second image portion with at least one template image associated with the face portion; and generating at least one distortion-free second image portion and at least one distortion-free first image portion, respectively based on the one or more distortion parameters, wherein, generating the at least one distortion-free second image portion comprises applying the one or more distortion parameters to the at least one second image portion, and wherein, generating the at least one distortion-free first image portion comprises, performing one of: applying the one or more distortion parameters associated with the at least one second image portion to the at least one first image portion, and estimating one or more distortion parameters associated with the at least one first image portion based on the one or more distortion parameters associated with the at least one second image portion, and applying, the one or more distortion parameters associated with the at least one first image portion to the at least one first image portion.

In a third embodiment, there is provided an apparatus comprising at least one processor; and at least one memory comprising computer program code, the at least one memory and the computer program code configured to, with the at least one processor, cause the apparatus to perform at least: facilitate capture of a first image by a first camera and a second image by a second camera associated with a device, the first image and the second image being captured simultaneously; determine one or more distortion parameters associated with a distortion in the second image based on a comparison of the second image with at least one template image associated with the second image; and generate a distortion-free first image based on the determination of the one or more distortion parameters associated with the second image, wherein to generate the distortion-free first image, the apparatus is caused to perform one of: apply the one or more distortion parameters associated with the second image to the first image, and estimate one or more distortion parameters associated with the first image based on the one or more distortion parameters associated with the second image, and applying, the one or more distortion parameters associated with the first image to the first image.

In a fourth embodiment, there is provided an apparatus comprising at least one processor; and at least one memory comprising computer program code, the at least one memory and the computer program code configured to, with the at least one processor, cause the apparatus to perform at least: facilitate capture of an image comprising at least one first image portion and at least one second image portion, the at least one second image portion comprising a face portion; determine one or more distortion parameters associated with a distortion in the at least one second image portion based on a comparison of the at least one second image portion with at least one template image associated with the face portion; and generate at least one distortion-free second image portion and at least one distortion-free first image portion, respectively based on the one or more distortion parameters, wherein, to generate the at least one distortion-free second image portion, the apparatus is caused to apply the one or more distortion parameters to the at least one second image portion, and wherein, to generate the at least one distortion-free first image portion, the apparatus is caused to perform one of: apply the one or more distortion parameters associated with the at least one second image portion to the at least one first image portion, and estimate one or more distortion parameters associated with the at least one first image portion based on the one or more distortion parameters associated with the at least one second image portion, and applying, the one or more distortion parameters associated with the at least one first image portion to the at least one first image portion.

In a fifth embodiment, there is provided a computer program product comprising at least one computer-readable storage medium, the computer-readable storage medium comprising a set of instructions, which, when executed by one or more processors, cause an apparatus to perform at least: facilitate capture of a first image by a first camera and a second image by a second camera associated with a device, the first image and the second image being captured simultaneously; determine one or more distortion parameters associated with a distortion in the second image based on a comparison of the second image with at least one template image associated with the second image; and generate a distortion-free first image based on the determination of the one or more distortion parameters associated with the second image, wherein to generate the distortion-free first image, the apparatus is caused to perform one of: apply the one or more distortion parameters associated with the second image to the first image, and estimate one or more distortion parameters associated with the first image based on the one or more distortion parameters associated with the second image, and applying, the one or more distortion parameters associated with the first image to the first image.

In a sixth embodiment, there is provided a computer program product comprising at least one computer-readable storage medium, the computer-readable storage medium comprising a set of instructions, which, when executed by one or more processors, cause an apparatus to perform at least: facilitate capture of an image comprising at least one first image portion and at least one second image portion, the at least one second image portion comprising a face portion; determine one or more distortion parameters associated with a distortion in the at least one second image portion based on a comparison of the at least one second image portion with at least one template image associated with the face portion; and generate at least one distortion-free second image portion and at least one distortion-free first image portion, respectively based on the one or more distortion parameters, wherein, to generate the at least one distortion-free second image portion, the apparatus is caused to apply the one or more distortion parameters to the at least one second image portion, and wherein, to generate the at least one distortion-free first image portion, the apparatus is caused to perform one of: apply the one or more distortion parameters associated with the at least one second image portion to the at least one first image portion, and estimate one or more distortion parameters associated with the at least one first image portion based on the one or more distortion parameters associated with the at least one second image portion, and applying, the one or more distortion parameters associated with the at least one first image portion to the at least one first image portion.

In a seventh embodiment, there is provided an apparatus comprising: means for facilitating capture of a first image by a first camera and a second image by a second camera associated with a device, the first image and the second image being captured simultaneously; means for determining one or more distortion parameters associated with a distortion in the second image based on a comparison of the second image with at least one template image associated with the second image; and means for generating a distortion-free first image based on the determination of the one or more distortion parameters associated with the second image, wherein to means for generating the distortion-free first image comprises: means for applying the one or more distortion parameters associated with the second image to the first image, and means for estimating one or more distortion parameters associated with the first image based on the one or more distortion parameters associated with the second image, and applying, the one or more distortion parameters associated with the first image to the first image.

In an eight embodiment, there is provided an apparatus comprising: means for facilitating capture of an image comprising at least one first image portion and at least one second image portion, the at least one second image portion comprising a face portion; means for determining one or more distortion parameters associated with a distortion in the at least one second image portion based on a comparison of the at least one second image portion with at least one template image associated with the face portion; and means for generating at least one distortion-free second image portion and at least one distortion-free first image portion, respectively based on the one or more distortion parameters, wherein, means for generating the at least one distortion-free second image portion comprises means for applying the one or more distortion parameters to the at least one second image portion, and wherein, means for generating the at least one distortion-free first image portion comprises means for applying the one or more distortion parameters associated with the at least one second image portion to the at least one first image portion, and means for estimating one or more distortion parameters associated with the at least one first image portion based on the one or more distortion parameters associated with the at least one second image portion, and applying, the one or more distortion parameters associated with the at least one first image portion to the at least one first image portion.

In a ninth embodiment, there is provided a computer program comprising program instructions which when executed by an apparatus, cause the apparatus to: facilitate capture of a first image by a first camera and a second image by a second camera associated with a device, the first image and the second image being captured simultaneously; determine one or more distortion parameters associated with a distortion in the second image based on a comparison of the second image with at least one template image associated with the second image; and generate a distortion-free first image based on the determination of the one or more distortion parameters associated with the second image, wherein to generate the distortion-free first image, the apparatus is caused to perform one of: apply the one or more distortion parameters associated with the second image to the first image, and estimate one or more distortion parameters associated with the first image based on the one or more distortion parameters associated with the second image, and applying, the one or more distortion parameters associated with the first image to the first image.

In a tenth embodiment, there is provided a computer program comprising program instructions which when executed by an apparatus, cause the apparatus to: facilitate capture of an image comprising at least one first image portion and at least one second image portion, the at least one second image portion comprising a face portion; determine one or more distortion parameters associated with a distortion in the at least one second image portion based on a comparison of the at least one second image portion with at least one template image associated with the face portion; and generate at least one distortion-free second image portion and at least one distortion-free first image portion, respectively based on the one or more distortion parameters, wherein, to generate the at least one distortion-free second image portion, the apparatus is caused to apply the one or more distortion parameters to the at least one second image portion, and wherein, to generate the at least one distortion-free first image portion, the apparatus is caused to perform one of: apply the one or more distortion parameters associated with the at least one second image portion to the at least one first image portion, and estimate one or more distortion parameters associated with the at least one first image portion based on the one or more distortion parameters associated with the at least one second image portion, and applying, the one or more distortion parameters associated with the at least one first image portion to the at least one first image portion.

### BRIEF DESCRIPTION OF THE FIGURES

Various embodiments are illustrated by way of example, and not by way of limitation, in the figures of the accompanying drawings in which:

FIG. 1 illustrates a device, in accordance with an example embodiment;

FIG. 2 illustrates an apparatus for blur estimation in images, in accordance with an example embodiment;

FIGS. 3A and 3B illustrates examples of using a device for blur estimation in images, in accordance with an example embodiment;

FIG. 4 is a flowchart depicting an example method for blur estimation in images, in accordance with an example embodiment;

FIG. 5 is a flowchart depicting an example method for blur estimation in images, in accordance with another example embodiment;

FIG. 6 is a flowchart depicting an example method for blur estimation in images, in accordance with yet another example embodiment; and

FIG. 7 is a flowchart depicting an example method for blur estimation in images, in accordance with still another example embodiment.

### DETAILED DESCRIPTION

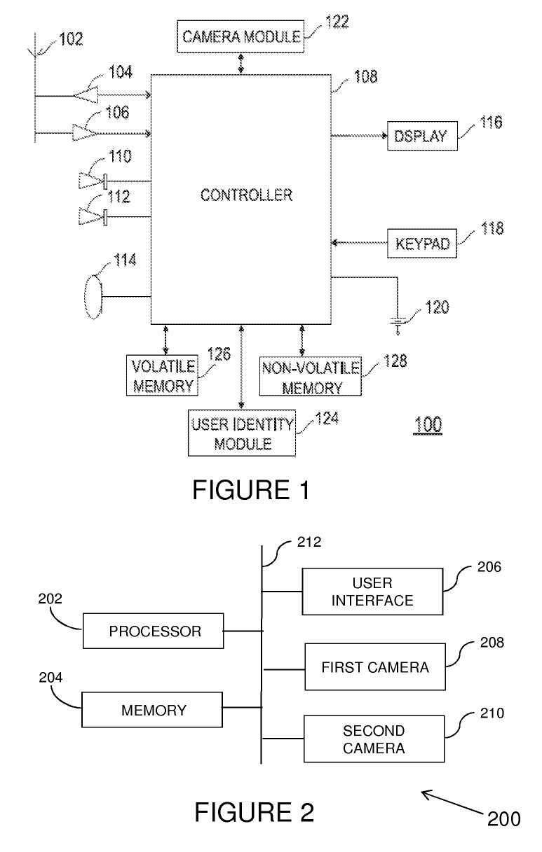

Example embodiments and their potential effects are understood by referring to FIGS. 1 through 7 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means configured for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

FIG. 2 illustrates an apparatus 200 for blur estimation in images, in accordance with an example embodiment). The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices). Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some examples of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108 of FIG. 1. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the electronic device may include a mobile phone, a personal digital assistant (PDA), and the like. Some examples of computing device may include a laptop, a personal computer, and the like. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus 200 or circuitry to perform the functions of the transceiver. The transceiver may be configured to receive media content. Examples of media content may include audio content, video content, data, and a combination thereof.

In an example embodiment, the electronic device may be embodied as to include a first camera, such as a first camera 208 and a second camera such as a second camera 210. The first camera 208 and the second camera 210 may be in communication with the processor 202 and/or other components of the apparatus 200. The first camera 208 and the second camera 210 may be in communication with other imaging circuitries and/or software, and are configured to capture digital images or to make a video or other graphic media files. In an example embodiment, the first camera 208 and the second camera 210 and other circuitries, in combination, may be an example of the camera module 122 of the device 100.

In an example embodiment, the first camera 208 may be a ‘rear-facing camera’ of the apparatus 200. In an example embodiment, the ‘rear-facing camera’ may be configured to capture rear-facing images from the apparatus 200. The first camera 208 may be configured to capture images/videos in a direction facing opposite to or away from the user on another side of the display screen associated with the apparatus 200. In an example embodiment, the first camera 208 may capture image/video of a scene. Herein, the term ‘scene’ may refer to an arrangement (natural, manmade, sorted or assorted) of one or more objects of which images and/or videos may be captured.

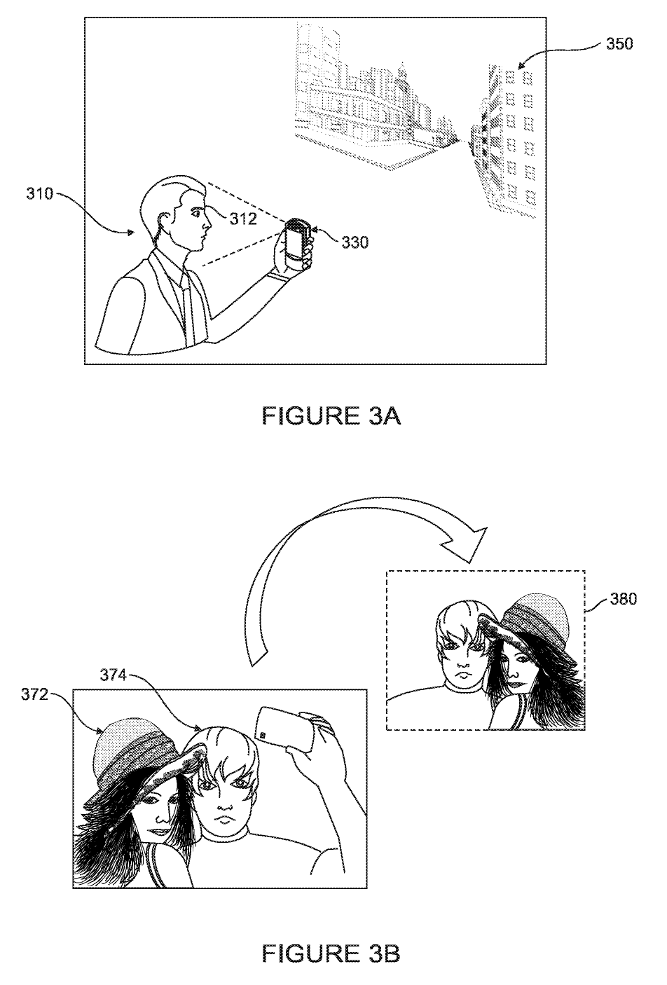

In an example embodiment, the second camera 210 may be a ‘front-facing camera’ of the apparatus 200, and may be configured to capture front-facing images from the apparatus 200. The second camera 210 may be configured to capture images/videos in a direction facing the user on a same side of the display screen associated with the apparatus 200. In some example scenarios, the front-facing camera or the second camera 210 may be called as a ‘selfie’ camera or a ‘webcam’. An example of the capturing images using the front-facing camera and the rear-facing camera are illustrated and described with reference to FIGS. 3A-3B.

These components (202-210) may communicate to each other via a centralized circuit system 212 to perform blur-estimation in images. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 212 may also, or alternatively, include other printed circuit assemblies (PCAs) or communication channel media.

In an example embodiment, the processor 202 is configured to, with the content of the memory 204, and optionally with other components described herein, to cause the apparatus 200 to facilitate capturing of a first image from the first camera 208 and the second image from the second camera 210 associated with the apparatus 200. In an example embodiment, the first image and the second image may be captured simultaneously. In an example embodiment, the simultaneous capture of the first image and the second image may refer to facilitating access to the first camera 208 and the second camera 210 almost at the same time. For example, when the first camera 208 is accessed for capturing the first image, the apparatus 200 may be caused to activate the second camera 210, so that the second image and the first image are captured simultaneously. In an example embodiment, a processing means may be configured to facilitate capture of the first image by the first camera 208 and the second image by the second camera 210 associated with a device. An example of the processing means may include the processor 202, which may be an example of the controller 108, and/or the cameras 208 and 210.

In an example embodiment, the apparatus 200 may be configured to compute an exposure value for the first camera 208. Herein, the term ‘exposure’ may refer to an amount of light received by an image sensor associated with the first camera 208. The exposure may be determined based on an aperture and shutter-speed associated with a camera, for example the first camera 208. The aperture of the lens associated with the first camera 208 may determine the width of the lens diaphragm that may be opened during the image capture. The shutter speed may be determined by the amount of time for which the sensor associated with the first camera is exposed. Herein, the term ‘exposure value’ is representative of the amount of exposure to the light that may be generated by a combination of an aperture, shutter-speed and light sensitivity. In an example embodiment, the exposure value of the first camera may be determined based on a light metering technique. In an example embodiment, according to the light metering technique, the amount of light associated with the scene may be measured and in accordance with the same, a suitable exposure value may be computed for the camera, for example, the first camera. In an example embodiment, the light metering method may define which information of the scene may be utilized for calculating the exposure value, and how such information may be utilized for calculating the exposure value. In an example embodiment, a processing means may be configured to compute the exposure value for the first camera. An example of the processing means may include the processor 202, which may be an example of the controller 108.

In an example embodiment, the apparatus 200 may be configured to assign the computed exposure value to the second camera. In an example embodiment, assigning the exposure value computed for the first camera to the second camera may facilitate in maintaining the same or nearly same exposure while capturing the first image and the second image. In an example embodiment, a processing means may be configured to assign the computed exposure value to the second camera. An example of the processing means may include the processor 202, which may be an example of the controller 108.

In an example scenario, during acquisition/capturing of the first image and the second image by a device such as the device 100 embodying the apparatus 200, the first image and the second image may be captured as distorted images. For example, the first image and the second image may be captured as blurred images. The common causes of blurring may include lens imperfections, air turbulence, camera sense motion or random noise. For instance, while capturing the images by holding the device in a hand thereof, a user may have a shaking hand, thereby leading to a blurred or a shaky image. In another example scenario, the user may be capturing the images in a difficult environment such as on a moving train or while walking, thereby causing the device to shake. In some other example scenarios, the device may be utilized for capturing the images using only a single hand or without any additional support such as a tripod.

In an example embodiment, for removing distortion in the captured image for example the first image, the apparatus 200 may be caused to determine one or more distortion parameters indicative of a distortion in the second image. In an example embodiment, the one or more distortion parameters may be computed based on a non-blind de-convolution of the second image. In an example embodiment, in order to make the computation of the one or more parameters as a non-blind de-convolution, a comparison of the second image with a template image associated with the second image is performed. In this example embodiment, the second image may include a face portion such as a face portion of a user holding the device. Also, the template image associated with the second image may be a non-blurred or a sharp image of the face portion of the user. In some example embodiments, the apparatus 200 may be caused to capture the plurality of template images associated with face regions and store the same in the memory 204. Alternatively, in some other example embodiments, the plurality of template images may be prerecorded, stored in the apparatus 200, or may be received from sources external to the apparatus 200. In such example embodiments, the apparatus 200 is caused to receive the plurality of template images from external storage medium such as DVD, Compact Disk (CD), flash drive, memory card, or received from external storage locations through Internet, Bluetooth®, and the like.

In an example embodiment, for computing the one or more distortion parameters associated with the second image (by comparing the second image with the template image associated with the second image), the apparatus 200 may first detect and identify the face portion in the second image. Based on the detection of the face portion in the second image, the apparatus 200 may further be caused to identify the template image associated with the face portion in the second image. In an example embodiment, the apparatus 200 may be caused to identify the face portion in the second image, by for example, a suitable face recognition algorithm. For example, the apparatus 200 may be caused to detect the face portion in the second image based on one or more facial features. In an example embodiment, the second image may be corrected for scale and orientation of the face portion in the second image. In an example embodiment, a pair of eyes on the face portion may be utilized as reference points for performing a transformation on the scale and orientation of the face portion on the second image. For instance, on detecting the face portion, the apparatus 200 may detect a pair of eyes in the face portion. In an example embodiment, a straight line connecting the pair of eyes may be formed, and thereafter the face portion may be aligned in such a manner that the straight line may be parallel to a horizontal line. In an example embodiment, on identifying the face portion of the user, the apparatus 200 may be caused to detect the template image (such as the non-blurred image of the face portion of the user) associated with the second image from among the plurality of template images. In an example embodiment, the apparatus 200 may be caused to identify the template image associated with the second image based on a comparison of the second image (or the face portion of the user) with the plurality of template images. For example, the user holding the apparatus 200 may capture a first image using a rear-facing camera (i.e. the first camera) of the apparatus 200. Almost at the same time, the front facing camera (i.e. the second camera) may capture the second image i.e. the face portion of the user holding the apparatus 200. The captured second image of the face portion of the user may be compared with a plurality of face portion images stored in the memory 204. The plurality of face portion images stored in the memory 204 may be non-blurred or sharp (or distortion free) images of the face portions.

In an example embodiment, the apparatus 200 may be caused to select a template image corresponding to second image from among the plurality of template images. In an example embodiment, based on a comparison of the second image with the template image associated with the template image, the apparatus 200 may be caused to compute one or more distortion parameters associated with the second image. In an example embodiment, the one or more distortion parameters associated with the second image may include a blur kernel of the second image. In an example embodiment, the blur kernel may include PSF of the motion blur, associated with the second camera. In an example embodiment, the one or more distortion parameters associated with the second image may be determined by non-blind de-convolution of the second image since a blurred image (Y) as well as a sharp template image (X) for the face portion of the user are known. In an example embodiment, the model of non-blind de-convolution assumes that the input images (such as a blurred image of an object) may be related to an unknown image (such as a sharp image of the object), as demonstrated in equation (1) below:

Y=K*X+n, (1)

where,

Y is the second image (which is a blurred image) and X is the template image (which is a sharp image corresponding to the second image) associated with Y. Here, Y, i.e. the blurred second image is captured by the device, and X, i.e. the sharp image is determined after performing face-recognition,

K is the blur kernel which forms the PSF of the motion blur associated with the second camera. Here, K is to be estimated, and

n is a noise component.

In another example embodiment, the one or more distortion parameters of the second image may be computed without using the face recognition algorithm. In the present embodiment, the at least one template image associated with the second image may include a plurality of face region images. In the present embodiment, the apparatus 200 may be caused to determine the one or more distortion parameters associated with the distortion in the second image by performing a blind de-convolution of the second image, wherein during the process of blind de-convolution, a ‘regularization’ may be applied. It will be noted that the regularization may facilitate in constraining the process of blind de-convolution so as to avoid unrealistic solutions.

In an example embodiment, the regularization may be applied based on a distribution space function f(X) associated with the plurality of template images, where the plurality of template images include a plurality of face regions. Herein, the distribution space function may utilize the plurality of template images associated with face regions, thereby constraining the distributing space function to face distribution space only, and thus the blur kernel of the second image may be estimated accurately and in a computationally efficient manner. In an example embodiment, the distribution space function f(K,X) may be modeled as below for estimating the blur kernel of the second image accurately based on equation (2):

f(K,X)=∥Y−K*X∥²+lambda*[distribution−space (X)], (2)

where, the term {lambda*[distribution−space (X)]} is the regularization term.

Herein, the distribution space function f(X) may be taken on the gradient of the natural images i.e., gradient on X being a sparse distribution. In an example embodiment, the gradient may be taken on a smaller distribution space of a plurality of face regions, thereby facilitating in estimating the X and K more accurately.

On determining the blur kernel of the second image, a non-blurred or sharp first image (X′) may be estimated based on the one or more distortion parameters (K) of the second image. Herein, the estimation of the sharp first image (X′) may become a non-blind de-convolution, as Y′ (i.e., the blurred first image) and K′ (which may be a predetermined function of the blur kernel K, estimated from the second image) are known, and only X′ needs to be estimated. In an example embodiment, the apparatus 200 may be caused to generate a distortion-free deblurred first image based on the one or more distortion parameters of the second image. In an example embodiment, the distortion-free deblurred first image may be generated by applying the one or more distortion parameters to the first (Y′) image which is blurred. In an example embodiment, the blur kernel (K) of the second image may be directly applied for estimating the non-blurred first image, in case inplane transformations (like inplane translations or inplane rotation) are to be applied to the first image. Herein, the ‘inplane transformations’ may refer to arithmetic operations on images or complex mathematical operations that may convert images from one representation to other. In another example embodiment, the PSF for the first image may be a flipped version of the PSF estimated from the second image, in case out of plane transformations are to be applied to the first image. In an example embodiment, PSF may be flipped in both X and Y direction, i.e., if K(x,y) is the 2-dimensional blur kernel of the second image, then the blur kernel for the first image may be K(-x,-y). In an example embodiment, since the distortion is unknown, the distortion may be constrained to be inplane only and same PSF (as estimated for the motion blur of the second camera) may be utilized for determining the distortion-free first image. In another embodiment, both the inplane transformation and the out-of-plane transformation may be applied to the first image, so that the distortion for the first image may be combination of the PSF (K) estimated from the second image and the flipped version of the PSF (K) estimated from the second image. It will be noted that the relationship between the PSF/blur kernel (K) of the first image and the PSF/blur kernel (K′) of the second image may be pre-determined. For example, the relationship between the blur kernels K and K′ may be determined experimentally.

In the foregoing embodiments, first the PSF (K) associated with the motion blur of the second camera is determined based on the sharp (X) and the blurred images (Y) of the face portion of the user, and thereafter the same PSF (K) is utilized to estimate the distortion-free first image. An advantage of this approach for estimating the distortion-free first image is that the sharp/distortion-free first image (X′) of the scene may be estimated by performing non-blind de-convolution of the first image. In case, the PSF (K′) is not estimated/known, then both of the PSF/blur kernel (K′) as well as the sharp first image (X′) for the first image may be unknown, and then blind de-convolution is to be performed for determining the sharp first image (X′), which may be costly and time-consuming.

As disclosed herein, the apparatus 200 may be caused to determine the one or more distortion parameters indicative of blur/distortion in the front-facing image (such as the second image), and apply the one or more distortion parameters to the rear-facing image (such as the first image), thereby facilitating in deblurring the first image. In another example embodiment, the apparatus 200 may be caused to facilitate the deblurring of the images captured using the front-facing camera only. Such an image may be known as front-facing image or a ‘selfie’. An example illustrating a front-facing image/selfie being captured by a device is illustrated and described further with reference to FIG. 3B.

In an example embodiment, the apparatus 200 may be caused to facilitate capture of an image that may be a front-facing image. In an example embodiment, the image may be captured by using the second camera, which may be a ‘front-facing camera’ of the apparatus 200. The second camera along with the second camera 210 may be configured to capture images/videos in a direction facing the user on a same side of the display screen associated with the apparatus 200. In some example scenarios, the front camera may be called as a ‘selfie’ camera or a ‘webcam’.

In an example embodiment, the image may include at least one first image portion and at least one second image portion. In an example embodiment, the at least one second image portion may include at least one face portion, while the at least one first image portion may include one or more remaining portions of the image. For example, the image may be a ‘selfie’ image of a face portion of a user capturing the image along with the face portion of another person. In such a scenario, the face portion of the user may be the at least one second image portion while the face portion of other person may be the at least one first image portion. In another example scenario, the image may include foreground having a face portion of a user capturing the image, and a background having a beach, sea, sky, birds, and so on. In this example scenario, the at least one second image portion may include the face portion of the user and the at least one first image portion (or the remaining one or more image portions) may include the background having the beach, sea, sky, and birds.

In an example embodiment, the captured image may be distorted or blurred. In the present embodiment, the apparatus 200 may be configured to determine one or more distortion parameters associated with a distortion in the at least one second portion of the image. For example, the apparatus 200 may determine the one or more distortion parameters associated with a distortion in the face portion. In an example embodiment, the one or more distortion parameters may be indicative of the extent of blurring in the face portion associated with the at least one second image portion. In an example embodiment, the apparatus 200 may be caused to determine the one or more distortion parameters based on a comparison of the at least one second image portion with at least one template image associated with the face portion. In an example embodiment, the one or more distortion parameters may be computed by performing the non-blind de-convolution of the at least one second image portion with the at least one template image. In an example embodiment, the non-blind de-convolution may be modeled as described in the equation (1). In another example embodiment, the one or more distortion parameters may be determined by performing blind de-convolution of the at least one second image portion, where during the process of blind de-convolution, a regularization may be performed based on a distribution space function associated with the face regions. In an example embodiment, the blind de-convolution may be modeled as described in the equation (2). Example embodiments describing methods for performing the non-blind de-convolution and a constrained blind de-convolution to compute the one or more distortion parameters are described further in detail with reference to FIG. 7.

Various suitable techniques may be used to facilitate blur estimation in images. Some example embodiments of facilitating blur estimation in images are described further in the following description, however, these example embodiments should not be considered as limiting to the scope of the present technology.

FIG. 3A illustrates an example of using a device for blur estimation in images, in accordance with an example embodiment. As illustrated in FIG. 3A, a user 310 is shown to hold a device 330. The device 330 may be an example of the device 100 (FIG. 1). In an example embodiment, the device 330 may embody an apparatus such as the apparatus 200 (FIG. 2) that may be configured to perform blur estimation in the images captured by the device 330. In an example embodiment, the device 330 may include a first camera such as the first camera 208 (FIG. 2) and a second camera such as the second camera 210 (FIG. 2). In an example embodiment, the first camera may be a front-view camera and may be configured to capture a first image. In an example embodiment, the first image may be an image of a front side of the device 330. For example, the first image camera may be configured to capture the image of a scene, such as a scene 350 illustrated in FIG. 3A. The scene 350 is shown to include buildings, road, sky and so on. In an example embodiment, the second image camera may be a rear-view camera and may be configured to capture image of a rear side of the device 330. In an example embodiment, the image of the rear side of the device 330 may be a second image. In an example embodiment, the second image may include a face portion 312 of the user 310 holding the device 330.

In an example embodiment, the user 310 of the device 330 may initiate capturing of the first image, i.e. the image of the scene 350, by for example, providing a user input through a user interface of the device 330. On initiating the capture of the image of the scene 350 from the front-view camera of the device 330, the apparatus associated with the device 330, may facilitate in activating or switching-on the rear-view camera of the device 330, such that the rear-view camera and the front-view camera may simultaneously capture the images of a face portion 312 of the user 310 and the scene 350, respectively.

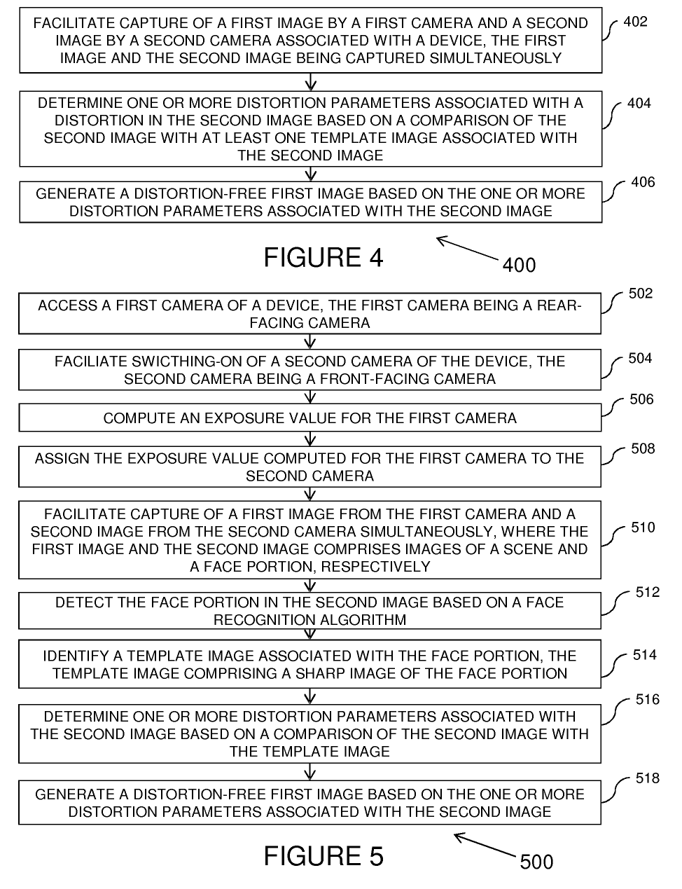

In an example scenario, the image of the scene 350 captured by the device 330 may be blurred, for example due to a shake of user's hand while capturing the images, or due to a difficult environment such as on a moving train or while walking, thereby causing the device 330 to shake. In an example embodiment, the first image being captured by the front-view camera may be deblurred by performing a non-blind de-convolution after estimating the blur kernel by performing a non-blind de-convolution of the second image. Various example scenarios of performing non-blind de-convolution of the second image are explained further with reference to FIGS. 4, 5 and 6.

FIG. 3B an example of using a device for blur estimation in images, in accordance with another example embodiment. In an example embodiment, the device may embody an apparatus such as the apparatus 200 (FIG. 2) that may facilitate in capturing images using a front-facing camera. In an example embodiment, the front-facing camera may capture images also known as ‘selfies’. In an example embodiment, in a selfie mode of the device, a user may hold or configure camera, for example the second camera 210 (FIG. 2) so as to click images of the ‘self’ and/or other objects of the scene using the front-facing camera.

In the example representation in FIG. 3B, two persons 372 and 374 are shown. The person 374 is shown as holding a device for capturing a ‘selfie’ image of himself along with that of the person 372. The selfie image captured at the device may be distorted. For example, the image captured may be a blurred image. In an example embodiment, the image may be blurred due to a variety of reasons such as wind turbulence, shaking of hand holding the device while taking the picture, and so on. In an example embodiment, the apparatus 200 may be configured to determine one or more distortion parameters associated with a distortion in at least a portion of the image. For example, the apparatus 200 may determine the one or more distortion parameters associated with a distortion in the face portion of the person 372. In an example embodiment, the one or more distortion parameters may be indicative of the extent of blurring in the face portion associated with the face portion of the person 372. Various example embodiments for determining the one or more distortion parameters associated with a distortion in the face portion are described further with reference to FIG. 7.

In an example embodiment, the one or more distortion parameters computed from the image of the face portion of the person 372 may be applied to face portion of the person 372 and the face portion of the person 374. In an example embodiment, on applying the one or more distortion parameters to the images of the face portions of the persons 372, 374 so as to generate a distortion-free image of the face portion of the persons 372, 374. Additionally or alternatively, on applying the one or more distortion parameters to the portions of the image other than the face portions of the persons 372, 374, distortion-free image of the rest of the regions of the image, for example, the background portions of the image, may be generated. An example of the distortion-free image being generated is shown as an inset 380 in FIG. 3B. Various example embodiments of performing generating distortion-free images are explained further with reference to FIGS. 4, 5, 6, and 7.

FIG. 4 is a flowchart depicting an example method 400 for blur estimation, in accordance with an example embodiment. The method 400 depicted in the flow chart may be executed by, for example, the apparatus 200 of FIG. 2. In various example scenarios, the blurring or a similar distortion may be caused in an image due to shaking or mishandling of an image-capturing device utilized for capturing the image.

At 402, the method 400 includes facilitating capture of a first image by a first camera and a second image by a second camera associated with the device. In an example embodiment, the first camera may be a front-facing camera, and may be configured to capture front-facing images from the device. In some example scenarios, the front-camera may be called as a ‘selfie’ camera or a ‘webcam’. In an example embodiment, the second camera may be a rear-camera of the device and may be utilized for capturing images of scenes at the rear side of the device. In an example embodiment, the first image and the second image may be captured simultaneously.

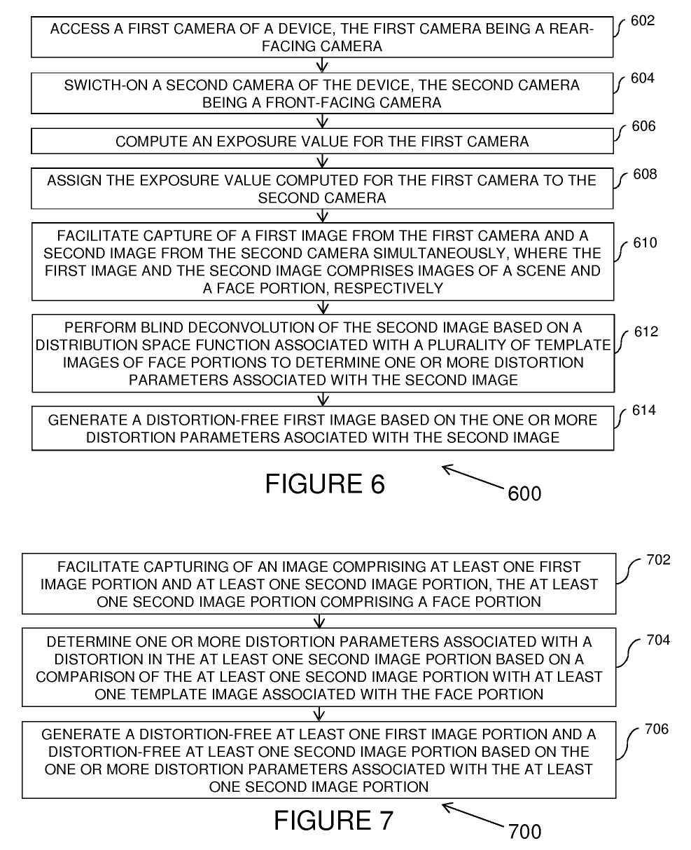

In an example embodiment, the device may be associated with a motion, for example due to reasons such as shaking of hand of a user holding the device, air turbulence, camera sense motion, and so on. Due to said motion, the images captured by the device may be distorted or blurred. In an example embodiment, the images captured by the device may be deblurred based on a determination of one or more distortion parameters associated with the captured images. In an example embodiment, the one or more distortion parameters may be indicative of a distortion in the captured images such as the first image and the second image. At 404, the method 400 includes determining the one or more distortion parameters associated with a distortion in the second image. In an example embodiment, the one or more distortion parameters may be computed based on a comparison of the second image with at least one template image associated with the second image. In an example embodiment, the one or more distortion parameters associated with the second image may include a blur kernel of the second image. In an example embodiment, the blur kernel may include point spread function (PSF) of the motion blur, associated with the second camera. In an example embodiment, the one or more distortion parameters associated with the second image may be determined by non-blind de-convolution of the second image since a blurred image (Y) as well as a sharp template image (X) for the face portion of the user are known. Various example embodiments for determining the one or more distortion parameters are explained further in detail with reference to FIGS. 5 and 6.

At 406, a distortion-free first image may be generated based on the one or more distortion parameters associated with the second image. In an example embodiment, the distortion-free first image may be generated based on the one or more distortion parameters associated with the second image to the first image. In an example embodiment, the one or more distortion parameters (K′) associated with the second image may be directly applied to the first image for estimating the distortion-free first image. In another example embodiment, the one or more distortion parameters (K′) or the blur kernel associated with the first image may be a flipped version of the PSF (K)/blur kernel associated with the second image. In an example embodiment, the estimated PSF (K′)/blur kernel of the first image may be a pre-determined transformation of the PSF/blur kernel of the second image.

FIG. 5 is a flowchart depicting example method 500 for blur estimation in images, in accordance with another example embodiment. The method depicted in this flow chart may be executed by, for example, the apparatus 200 of FIG. 2.

At 502, the method 500 includes accessing a first camera of a device. In an example embodiment, the first camera may be a rear-facing camera, and may be configured to capture rear-facing images from the device. In an example embodiment, the term ‘accessing’ may refer to a user action for activating/switching-on the first camera of the device. For example, the user action may include pressing a camera button on the device to activate a camera mode on the device. On accessing the first camera, a second camera associated with the device may be switched-on, at 504. In an example embodiment, the second camera may be a front-facing camera of the device. In some example scenarios, the front camera may be called as a ‘selfie’ camera or a ‘webcam’.

At 506, an exposure value for the first camera may be computed. The exposure may be determined based on the aperture and shutter-speed associated with a camera, for example the first camera. The aperture of the lens may determine the width of the lens diaphragm that may be opened. The shutter speed may determine the amount of time for which the image sensor, for example, the first image sensor is exposed. Herein, the term ‘exposure value’ is representative of the exposure generated by a combination of an aperture, shutter-speed and sensitivity. In an example embodiment, the exposure value of the first camera may be determined based on a light metering technique. For example, according to the light metering technique, the amount of light associated with the scene may be measured and a suitable exposure value may be computed for the camera, for example, the first camera. In an example embodiment, the light metering method may define which information of the scene may be utilized for calculating the exposure value, and how the exposure value may be determined based on said information. At 508, the exposure value computed for the first camera may be assigned to the second camera.

At 510, capturing of the first image using the first camera and the second image using the second camera may be facilitated. In an example embodiment, the first image and the second image may be captured simultaneously. In an example embodiment, the first image may include an image of a scene in front of the device while the second image may include a face portion image. In an example embodiment, the face portion image may include the image of the face portion of a user holding the device.

At 512, the face portion of the user may be detected in the second image. In an example embodiment, the face portion detected in the second image may not be oriented properly, and accordingly may be transformed so as to have a proper orientation and scaling. In an example embodiment, for transforming the second image, firstly the face portion in the second image may be detected by using a face recognition algorithm. In the detected face portion, a pair of eye may also be detected. The second image may be oriented in such a manner that a line connecting the pair of eyes may become parallel to a horizontal line in the second image. Additionally, the face portion in the second image may be scaled to a predetermined scale. In an example embodiment, the oriented and scaled image obtained from the second image may be utilized for deblurring the first image.

In an example scenario, during acquisition/capturing of the first image and the second image by the device, the first image and the second image may get distorted/deteriorated. For example, due to causes such as lens imperfections, air turbulence, camera sense motion or random noise, the captured image may be blurred. In an example embodiment, the extent of blurring of the second image may be estimated by computing one or more distortion parameters associated with the second image, and the computed one or more distortion parameters may be utilized for generating a deblurred second image. In an example embodiment, the one or more distortion parameters may include PSF associated with the motion blur of the device.

In an example embodiment, for computing the one or more distortion parameters, a template image associated with the face portion of the second image may be identified, at 514. In an example embodiment, the template image includes a sharp image of the face portion. In an example embodiment, the second image may be compared with the template image to determine one or more distortion parameters, at 516. In an example embodiment, the blurring phenomenon in an image, for example the first image may be modeled by a convolution with a blur kernel. The blur kernel may be known as a point spread function (PSF). In an example embodiment, a non-blind de-convolution may facilitate in recovery of a sharp image of the scene from a blurred first image of the scene. In an example embodiment, the non-blind de-convolution may be modelled as follows:

Y=K*X+n,

where,

Y is the second image and X is the template image associated with the second image,

K forms the PSF of the motion blur of the device, and

n is a noise component.

At 518, a distortion-free first image may be generated based on the one or more distortion parameters associated with the second image. In an example embodiment, the distortion-free first image may be generated by applying the one or more distortion parameters associated with the second image to the first image. In another example embodiment, one or more distortion parameters (K′) associated with the first image may be estimated based on the one or more distortion parameters (K) associated with the second image. The estimated one or more distortion parameters associated with the first image may be applied to the first image to generate the distortion-free first image. In an example embodiment, the one or more distortion parameters (K′) or the PSF associated with the motion blur of the first camera may include a flipped version of the PSF (K) associated with the motion blur of the second camera. In an example embodiment, the estimated PSF (K′)/blur kernel associated with the first image may be a pre-determined transformation of the PSF/blur kernel of the second image. Another method of estimating the one or more distortion parameters for estimating blurring in the images is described with reference to FIG. 6.

FIG. 6 is a flowchart depicting example method 600 for blur estimation in images, in accordance with another example embodiment. The methods depicted in these flow charts may be executed by, for example, the apparatus 200 of FIG. 2.

It will be noted that method 600 for blur estimation in images is similar to method 500 (FIG. 5). For example, the steps 602-610 of method 600 are similar to the steps 502-510 of the method 500, and accordingly the steps 602-610 are not explained herein for the brevity of description. In particular, the method 600 differentiates from the method 500 with respect to the process of estimating the one or more distortion parameters associated with the second image. In method 500, the estimation of the one or more distortion parameters is described with reference to 512-516, while in method 600 the estimation of the one or more distortion parameters is described with reference to 612.

As disclosed in method 600, in an example embodiment, the one or more distortion parameters may be determined based on a blind de-convolution of the second image, instead of performing a non-blind de-convolution (discussed with reference to FIG. 5). For example, at 612, a blind de-convolution of the second image may be performed based on a distribution space function f(K,X) associated with face region images. During the process of blind de-convolution, regularization may be applied to avoid unrealistic solutions. In the present embodiment, the one or more distortion parameters may include the PSF (K) associated with the motion blur of the second camera that may be estimated based on a distribution space function associated with the plurality of template images associated with face regions. The distribution space function may utilize the plurality of template images associated with face regions, thereby constraining the distributing space function to face distribution space, and thus the PSF/blur kernel associated with the second image may be assumed accurately. In an example embodiment, the distribution space function f(K,X) may be modeled as below for estimating the PSF/blur kernel accurately:

f(K,X)=∥Y−K*X∥²+lambda*[distribution−space (X)];

Here the term {lambda*[distribution−space (X)]} is the regularization term.

At 614, a distortion-free first image may be generated based on the one or more distortion parameters associated with the second image. In an example embodiment, the distortion-free first image may be a de-blurred first image. In an example embodiment, the distortion-free first image may be generated by applying the one or more distortion parameters associated with the second image to the first image. In another example embodiment, one or more distortion parameters (K′) associated with the first image may be estimated based on the one or more distortion parameters (K) associated with the second image. The estimated one or more distortion parameters associated with the first image may be applied to the first image to generate the distortion-free first image. In an example embodiment, the one or more distortion parameters (K′) or the PSF associated with the first image may include a flipped version of the PSF (K) associated with the second version. In an example embodiment, the estimated PSF (K′)/blur kernel of the first image may be a pre-determined transformation of the PSF/blur kernel of the second image.

FIG. 7 is a flowchart depicting example method 700 for blur estimation in images, in accordance with another example embodiment. The methods depicted in this flow chart may be executed by, for example, the apparatus 200 of FIG. 2. In an example embodiment, the apparatus 200 may be embodied in a device that may facilitate in capturing images using a front facing camera. In an example embodiment, the front facing camera may capture images also known as ‘selfies’. In an example embodiment, in a selfie mode, a user may hold the device embodying the apparatus 200 so as to click images of the ‘self’ and/or other objects of the scene using the front-facing camera. An example of a user capturing a ‘selfie’ image using the front-facing camera is illustrated and described with reference to FIG. 3B.

At 702, capture of an image having at least one first image portion and at least one second image portion is facilitated. In an example embodiment, the at least one second image portion may include a face portion. For example, the at least one second image portion may include a face portion of a user capturing the image in a selfie mode. In an example embodiment, the user may capture an image of himself/herself along with other persons and/or objects in a scene. In an example embodiment, the at least one first image portion may refer to portions and/or objects of the scene precluding the user's face portion. In some example embodiments, the at least one first image portion may include face portion of another person that may be posing for an image along with the user. In some other embodiments, the at least one first image portion may include other objects such as a vehicle, background regions or objects including trees, sky, roads and so on.

In an example embodiment, the image being captured by the user may be a distorted image. For example, the image may appear blurred due to shaking of user's hand holding the device. Various other reasons for blurring of the captured image may include difficult environments in which the image is captured, wind turbulence and so on. At 704, the method 700 includes determining one or more distortion parameters associated with a distortion in the at least one second image portion. In an example embodiment, the one or more distortion parameters may be indicative of the extent of blurring in the face portion associated with the at least one second image portion of the image.

In an example embodiment, the one or more distortion parameters may be determined based on a comparison of the at least one second image portion with at least one template image associated with the face portion. In an example embodiment, the at least one template image associated with the second image portion may be selected from among a plurality of template images. In an example embodiment, the template image includes a sharp image of the second image portion, i.e. the face portion. In some example embodiments, the plurality of template images associated with face regions may be captured and stored in a memory of the apparatus, such as the apparatus 200. Alternatively, in some other example embodiments, the plurality of template images may be prerecorded, stored in the apparatus 200, or may be received from sources external to the apparatus 200. In such example embodiments, the apparatus 200 is caused to receive the plurality of template images from external storage medium such as DVD, Compact Disk (CD), flash drive, memory card, or received from external storage locations through Internet, Bluetooth®, and the like.

In an example embodiment, the one or more distortion parameters may be determined by performing a non-blind de-convolution of the at least one second image portion with the template image associated with the at least one second image portion. In an example embodiment, the one or more distortion parameters may include PSF of a motion blur associated with the device. In an example embodiment, the PSF may be determined based on the following expression:

Y=K*X+n,

where,

Y is the second image portion and X is the template image associated with the second image portion,

K forms the PSF of the motion blur associated with the device, and

n is a noise component.

In the present embodiment, the one or more distortion parameters may include the PSF associated with the second image portion that may be estimated based on a distribution space function. In an example embodiment, the distribution space function may utilize the plurality of template images associated with face regions, thereby constraining the distributing space function to face distribution space only, and thus the PSF kernel associated with the second image portion may be assumed accurately. In an example embodiment, the distribution space function f(K,X) may be modeled as below for estimating the PSF kernel accurately:

f(K,X)=∥Y−K*X∥²+lambda*[distribution−space (X)];

Here the term {lambda*[distribution−space (X)]} is the regularization term.

At 706, the method 700 includes generating a distortion-free first image portion and a distortion-free second image portion based on the one or more distortion parameters associated with the first image portion. In an example embodiment, the distortion-free first image portion and the distortion-free second image portion includes a de-blurred first image portion and a distortion-free second image portion, respectively. In an example embodiment, the de-blurred second image portion may be generated by applying the one or more distortion parameter such as PSF associated with the second image portion to the second image portion.

In an example embodiment, the distortion-free first image portion may be generated by directly applying the one or more distortion parameters associated with the second image portion to the first image portion. In another example embodiment, one or more distortion parameters (K′) associated with the first image portion may be estimated based on the one or more distortion parameters (K) associated with the second image portion. The estimated one or more distortion parameters associated with the first image portion may be applied to the first image portion to generate the distortion-free first image portion. In an example embodiment, the one or more distortion parameters (K′) or the blur kernel associated with the first image portion may include a flipped version of the blur kernel (K) associated with the second image portion. In an example embodiment, the estimated PSF (K′)/blur kernel of the first image may be a pre-determined transformation of the PSF/blur kernel of the second image portion.

It should be noted that to facilitate discussions of the flowcharts of FIGS. 4 to 7, certain operations are described herein as constituting distinct steps performed in a certain order. Such implementations are examples only and non-limiting in scope. Certain operations may be grouped together and performed in a single operation, and certain operations may be performed in an order that differs from the order employed in the examples set forth herein. Moreover, certain operations of the methods 400, 500, 600, and 700 are performed in an automated fashion. These operations involve substantially no interaction with the user. Other operations of the methods 400, 500, 600, and 700 may be performed by in a manual fashion or semi-automatic fashion. These operations involve interaction with the user via one or more user interface presentations.

The operations of the flowcharts, and combinations of operation in the flowcharts, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture, the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods are described with help of apparatus 200. However, the operations of the methods can be described and/or practiced by using any other apparatus.

Without in any way limiting the scope, interpretation, or application of the claims appearing below, a technical effect of one or more of the example embodiments disclosed herein is to perform blur estimation in images. Various embodiments disclose methods for performing deblurring of images being captured by image capturing devices. In various embodiments, a non-blind de-convolution of a user's face image is performed to determine the extent of distortion in the user's face image. An advantage of this approach is that the non-blind de-convolution technique facilitates in performing de-blurring in a reliable and computationally efficient manner. In another embodiment, a blind de-convolution of the user's face image is performed. However, during the blind de-convolution, the regularization process is performed where a distribution space function associated with the face portion only images is utilized, thereby estimating the PSF/blur kernel accurately.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A non-transitory computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various embodiments are set out in the independent claims, other embodiments comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-63. (canceled)

64. A method comprising:
facilitating capture of a first image by a first camera and a second image by a second camera associated with a device, the first image and the second image being captured simultaneously;
determining one or more distortion parameters associated with a distortion in the second image based on a comparison of the second image with at least one template image associated with the second image; and
generating a distortion-free first image based on the determination of the one or more distortion parameters associated with the second image, wherein generating the distortion-free first image comprises performing one of:
applying the one or more distortion parameters associated with the second image to the first image, and
estimating one or more distortion parameters associated with the first image based on the one or more distortion parameters associated with the second image, and applying, the one or more distortion parameters associated with the first image to the first image.

65. The method as claimed in claim 64, further comprising:
detecting a switching-on of the first camera; and
switching-on the second camera on detecting the switching-on of the first camera.

66. The method as claimed in claim 64, further comprising:
computing an exposure value for the first camera, the exposure value for the first camera being indicative of an amount of exposure to light received by the first camera; and
assigning the exposure value computed for the first camera to the second camera.

67. The method as claimed in claim 64, wherein the first image comprises an image of a scene and the second image comprises an image of a face portion.

68. The method as claimed in claim 67, further comprising selecting the at least one template image associated with the second image from among a plurality of template images, wherein the at least one template image comprises a distortion-free image of the face portion.

69. The method as claimed in claim 64, wherein determining the one or more distortion parameters comprises performing a non-blind de-convolution of the second image with the at least one template image.

70. The method as claimed in claim 64, wherein the one or more distortion parameters associated with the second image comprises point spread function (PSF) of a motion blur associated with the second camera, the PSF being determined based on the following expression:
Y=K*X+n,
where,
Y is the second image and X is the at least one template image associated with the second image,
K is the PSF of the motion blur associated with the second camera, and
n is a noise component.

71. The method as claimed in claim 64, wherein the at least one template image comprises a plurality of face region images, and wherein the one or more distortion parameters are determined based on a distribution space function f(X) associated with the plurality of face region images.

72. An apparatus comprising:
at least one processor; and
at least one memory comprising computer program code, the at least one memory and the computer program code configured to, with the at least one processor, cause the apparatus to at least perform:
facilitate capture of a first image by a first camera and a second image by a second camera associated with a device, the first image and the second image being captured simultaneously;
determine one or more distortion parameters associated with a distortion in the second image based on a comparison of the second image with at least one template image associated with the second image; and
generate a distortion-free first image based on the determination of the one or more distortion parameters associated with the second image, wherein to generate the distortion-free first image, the apparatus is caused to perform one of:
apply the one or more distortion parameters associated with the second image to the first image, and
estimate one or more distortion parameters associated with the first image based on the one or more distortion parameters associated with the second image, and applying, the one or more distortion parameters associated with the first image to the first image

73. The apparatus as claimed in claim 72, wherein the apparatus is further caused, at least in part to:
detect a switching-on of the first camera; and
switch-on the second camera on detecting the switching-on of the first camera.

74. The apparatus as claimed in claim 72, wherein the apparatus is further caused, at least in part to:
compute an exposure value for the first camera, the exposure value for the first camera being indicative of an amount of exposure to light received by the first camera; and
assign the exposure value computed for the first camera to the second camera.

75. The apparatus as claimed in claim 72, wherein the first image comprises an image of a scene and the second image comprises an image of a face portion.

76. The apparatus as claimed in claim 73, wherein the apparatus is further caused, at least in part to select the at least one template image associated with the second image from among a plurality of template images, wherein the at least one template image comprises a distortion-free image of the face portion.

77. The apparatus as claimed in claim 72, wherein for determining the one or more distortion parameters, the apparatus is further caused, at least in part to perform a non-blind de-convolution of the second image with the at least one template image.

78. The apparatus as claimed in claim 72, wherein the one or more distortion parameters associated with the second image comprises point spread function (PSF) of a motion blur associated with the second camera, and wherein the apparatus is further caused, at least in part to determine the PSF based on the following expression:
Y=K*X+n,
where,
Y is the second image and X is the at least one template image associated with the second image,
K is the PSF of the motion blur associated with the second camera, and
n is a noise component.

79. The apparatus as claimed in claim 72, wherein the at least one template image comprises a plurality of face region images, and wherein the apparatus is further caused, at least in part to determine the one or more distortion parameters based on a distribution space function f(X) associated with the plurality of face region images.

80. An apparatus comprising:
at least one processor; and
at least one memory comprising computer program code, the at least one memory and the computer program code configured to, with the at least one processor, cause the apparatus to at least perform:
facilitate capture of an image comprising at least one first image portion and at least one second image portion, the at least one second image portion comprising a face portion;
determine one or more distortion parameters associated with a distortion in the at least one second image portion based on a comparison of the at least one second image portion with at least one template image associated with the face portion; and
generate at least one distortion-free second image portion and at least one distortion-free first image portion, respectively based on the one or more distortion parameters,
wherein, to generate the at least one distortion-free second image portion, the apparatus is caused to perform: apply the one or more distortion parameters to the at least one second image portion, and
wherein, to generate the at least one distortion-free first image portion, the apparatus is caused to perform one of:
apply the one or more distortion parameters associated with the at least one second image portion to the at least one first image portion, and
estimate one or more distortion parameters associated with the at least one first image portion based on the one or more distortion parameters associated with the at least one second image portion, and applying, the one or more distortion parameters associated with at least one the first image portion to the at least one the first image portion.

81. A computer program product comprising at least one computer-readable storage medium, the computer-readable storage medium comprising a set of instructions, which, when executed by one or more processors, cause an apparatus to at least perform:
facilitate capture of a first image by a first camera and a second image by a second camera associated with a device, the first image and the second image being captured simultaneously;
determine one or more distortion parameters associated with a distortion in the second image based on a comparison of the second image with at least one template image associated with the second image; and
generate a distortion-free first image based on the determination of the one or more distortion parameters associated with the second image, wherein to generate the distortion-free first image, the apparatus is caused to perform one of:
apply the one or more distortion parameters associated with the second image to the first image, and
estimate one or more distortion parameters associated with the first image based on the one or more distortion parameters associated with the second image, and applying, the one or more distortion parameters associated with the first image to the first image.

82. The computer program product as claimed in claim 81, wherein the apparatus is further caused, at least in part to:
compute an exposure value for the first camera, the exposure value for the first camera being indicative of an amount of exposure to light received by the first camera; and
assign the exposure value computed for the first camera to the second camera.

83. The computer program product as claimed in claim 81, wherein the first image comprises an image of a scene and the second image comprises an image of a face portion.
